(19) United States
(12) Patent Application Publication
(10) Pub. No.: US 2018/0111289 A1
(43) Pub. Date: Apr. 26, 2018

(54) SYSTEM FOR THE AUTOMATIC RELEASE OF PRODUCTS MADE FROM CAST CONCRETE FROM FLEXIBLE MOULDS

(71) Applicant: VORTEX HYDRA S.R.L, COPPARO (FE) (IT)

(72) Inventor: Adriano SAVORELLI, Ferrara (FE) (IT)

(21) Appl. No.: 15/567,871

(22) PCT Filed: May 19, 2016
(86) PCT No.: PCT/IB2016/052937

§ 371 Date: Oct. 19, 2017

(30) Foreign Application Priority Data
May 21, 2015 (IT) 102015000016624

(51) Int. Cl. B28B 13/06; B28B 5/02

(52) U.S. Cl. CPC B28B 13/062; B28B 7/06; B28B 5/02

(57) ABSTRACT

A system for the automatic release of cast concrete products from flexible and deformable moulds is described. The system has an apparatus configured to supply the moulds and carry out the pre-mould-release of the products contained within such moulds. The apparatus has a first conveyor belt associated with a first pre-mould-release group and a second conveyor belt associated with a second pre-mould-release group. The second conveyor belt is placed downstream of the first conveyor belt and both pre-mould-release groups are configured to facilitate the subsequent mould-release of the products. The system further has a mould-release machine arranged downstream with respect to the first and second conveyor belts. The mould-release machine has a mould-release group, configured to carry out the extraction of the products from the respective moulds, and a plurality of conveyor belts, configured to move the moulds and the products inside the mould-release machine.

The present invention relates to a system for the automatic release of concrete products, in particular cast concrete products from flexible and deformable dies or moulds.

Normally, the mould-release of cast concrete products, i.e. the extraction of these products, once dried, from the respective flexible and deformable moulds, is carried out manually. The moulds are generally made of rubber or deformable plastic. Hereinafter, for convenience, “rubber mould” will also be used to indicate a generic flexible and/or deformable mould made of other suitable materials.

A type of manual procedure for the mould-release of cast concrete products involves the overturning of the moulds on a conveyor belt, in such a way that the “noble” or shaped surface of the products is facing upwards. Thereafter, the rubber mould, starting from a front edge thereof, is lifted and flexed while keeping the products adhering to the underlying surface. In this way, the products are extracted from the mould, but such a procedure involves a waste of time and, depending on the size of the mould, can also result in the need to have more than one operator available for each mould.

Other manual procedures for the mould-release of cast concrete products do not require the overturning of the mould with the products inside, but carry out the extraction of the products with the “noble” or shaped part facing downwards. Similar procedures reduce the physical burden of the operator, but involve an increase in the time required, and therefore the costs, to carry out each extraction. Moreover, the manual repositioning of the mould in its tray/support is also a labour burden and may lead to a considerable waste of time.

Ultimately, the operation of manual extraction of the cast concrete products from the respective moulds always involves a great cost of labour. In addition, this operation may cause damage to the product, since it is not a controllable operation and mostly depends on the capacity and expertise of the single operators.

Therefore, some machines have been introduced on the market which facilitate the manual extraction of the products, forcing the moulds to flex through rigid mechanisms. This forced flexing, if not properly calibrated, could however “overstress” the rubber or, in general, the material with which the moulds are manufactured. Moreover, the current machines that facilitate the manual extraction of the products do not automatically adapt to the different types and shapes of moulds and product.

Document EP 1935597 A1 describes a machine for the mould-release of concrete products according to the preamble of claim 1. This machine comprises a rigid drum, set in rotation to extract the concrete products from flexible dies. However, the dies must necessarily be provided with a portion for the engagement with a hooking tooth provided on the rotating drum of the mould-release machine. It follows that the machine is configured to operate only with moulds having predetermined shape and size (in terms of length and thickness).

The object of the present invention is therefore to provide a system for the automatic release of concrete products, in particular cast concrete products, from flexible and deformable moulds or dies, that is able to solve the above-mentioned drawbacks of the prior art in an extremely simple, cost-effective and particularly functional manner.

In detail, an object of the present invention is to provide a system that is able to perform the automatic mould-release of cast concrete products from flexible dies using dies of any length and thickness, even if mixed together.

Another object of the present invention is to provide a system that is able to perform the automatic mould-release of cast concrete products from flexible dies in a quick and cost-effective manner.

A further object of the present invention is to provide a system that is able to perform the automatic mould-release of cast concrete products from flexible dies in an efficient and safe manner.

These and other objects according to the present invention are achieved by implementing a system for the automatic release of concrete products, in particular cast concrete products from flexible and deformable dies or moulds as described in claim 1.

Further features of the invention are highlighted in the dependent claims, which are an integral part of the present description.

In general, the system for the automatic release of products made from cast concrete from flexible moulds of the present invention comprises at least a first conveyor belt, configured to move the dies or moulds of resilient material with the dry products therein, whose “noble” or shaped surface is facing downwards. The system then comprises a mould-release machine which receives the dies or moulds from said conveyor belt. The mould-release machine consists of a plurality of apparatuses, typically consisting of movable and rotating brushes, configured to separate each product from the respective mould, as well as to convey each product on at least a second conveyor belt and each mould on a third conveyor belt, respectively.

The second conveyor is configured to convey the products out of the mould-release area, while the third conveyor belt is associated with at least one gripper configured to grip each mould and reposition it on one of the product manufacturing lines, arranged parallel to such a third conveyor belt. The automatic mould-release system is configured in such a way that, at the end of the mould-release process, each extracted product maintains its “noble” or shaped surface facing upwards.

The features and the advantages of a system for the automatic release of concrete products, in particular cast concrete products from flexible and deformable dies or moulds, according to the present invention will become apparent from the following exemplary and non-limiting description, made with reference to the accompanying schematic drawings, in which:

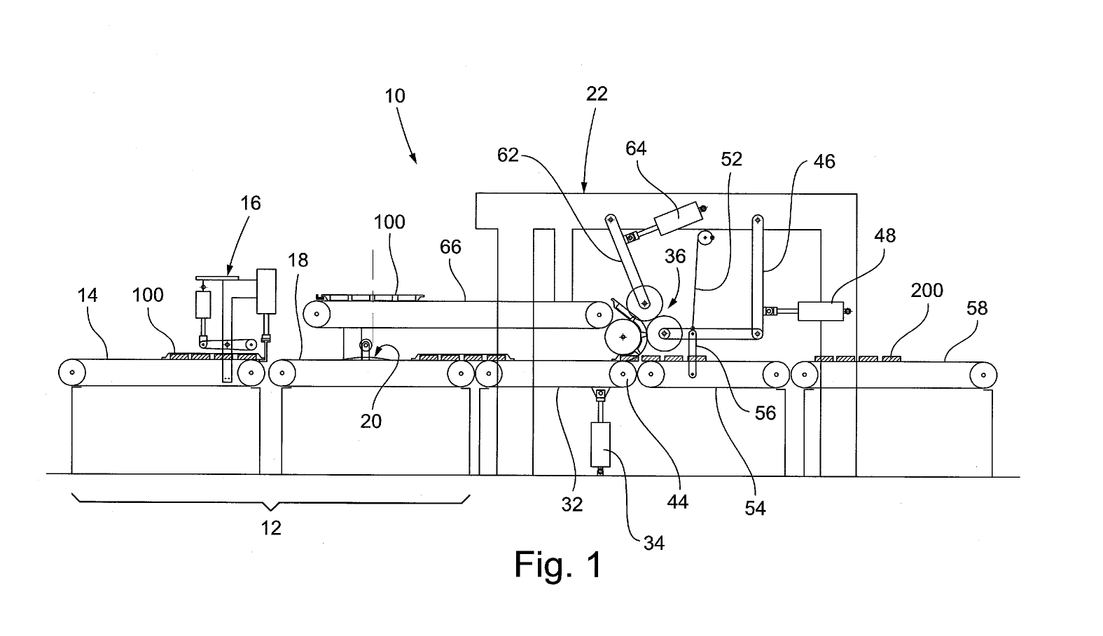

FIG. 1 is a schematic side elevation view of the main components of a preferred exemplary embodiment of the mould-release system according to the present invention;

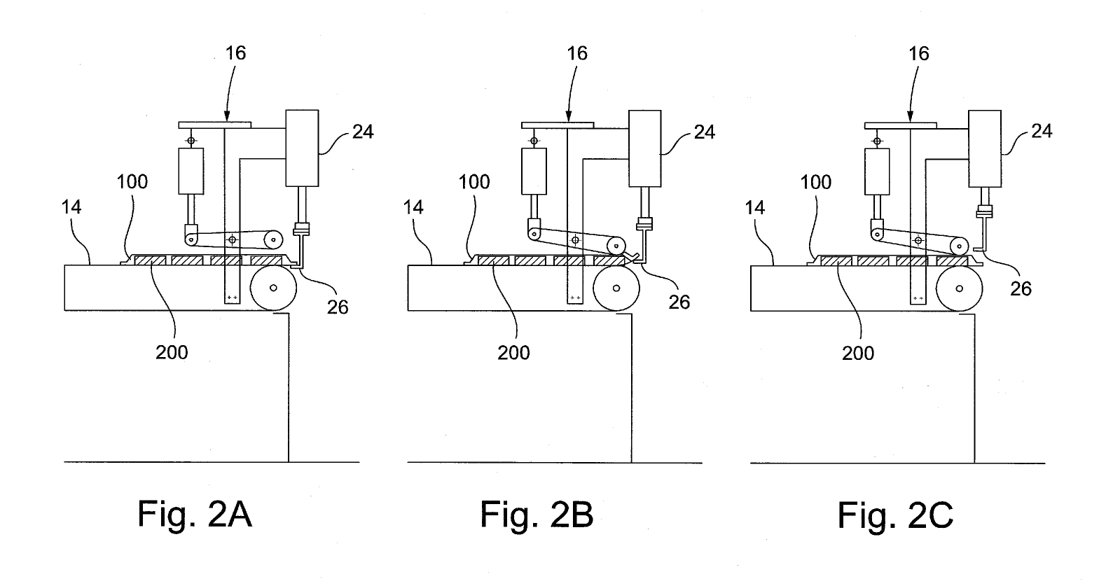

FIGS. 2A, 2B and 2C show three separate processing steps of the dies or moulds, containing the dried products, using the mould-release system of FIG. 1, respectively;

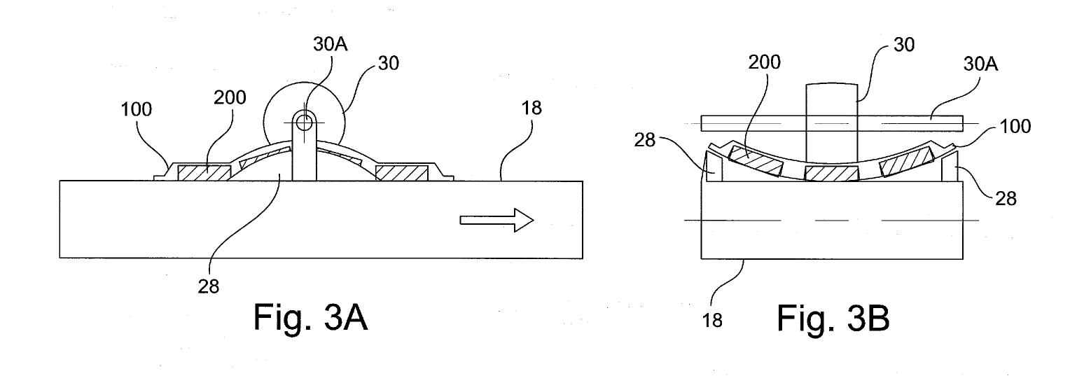

FIGS. 3A and 3B show side elevation and cross-section views, respectively, of a further processing step of the dies or moulds, containing the dried products, using the mould-release system of FIG. 1;

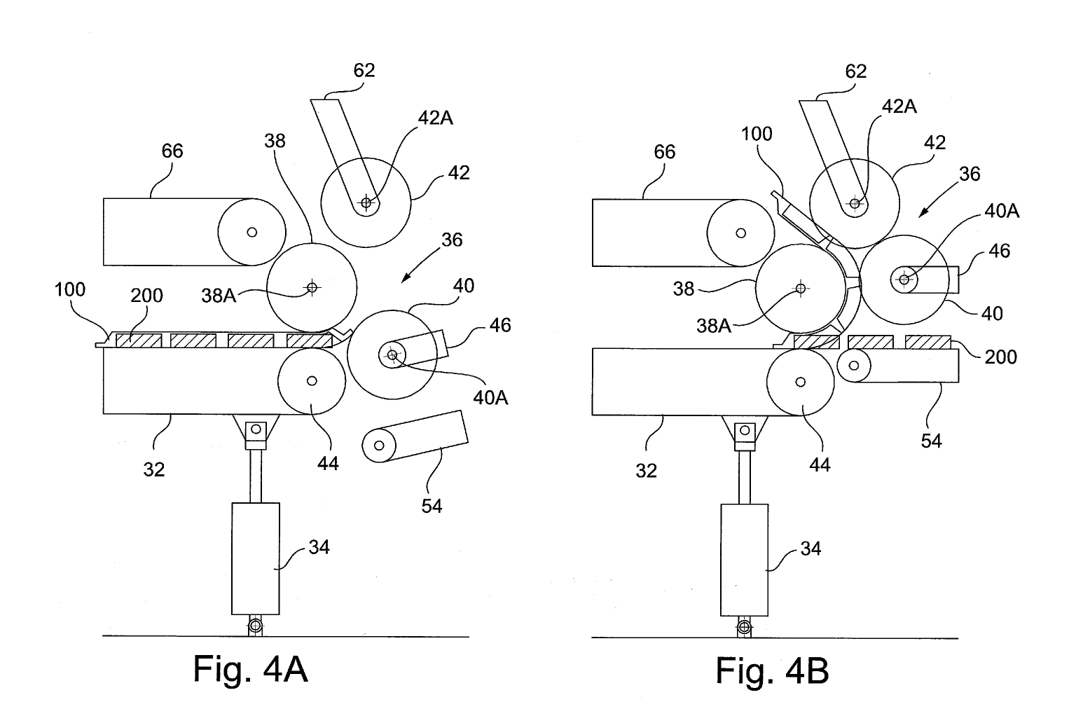

FIGS. 4A and 4B show two separate processing steps of the dies or moulds, from which the dried products are extracted, using the mould-release system of FIG. 1, respectively;

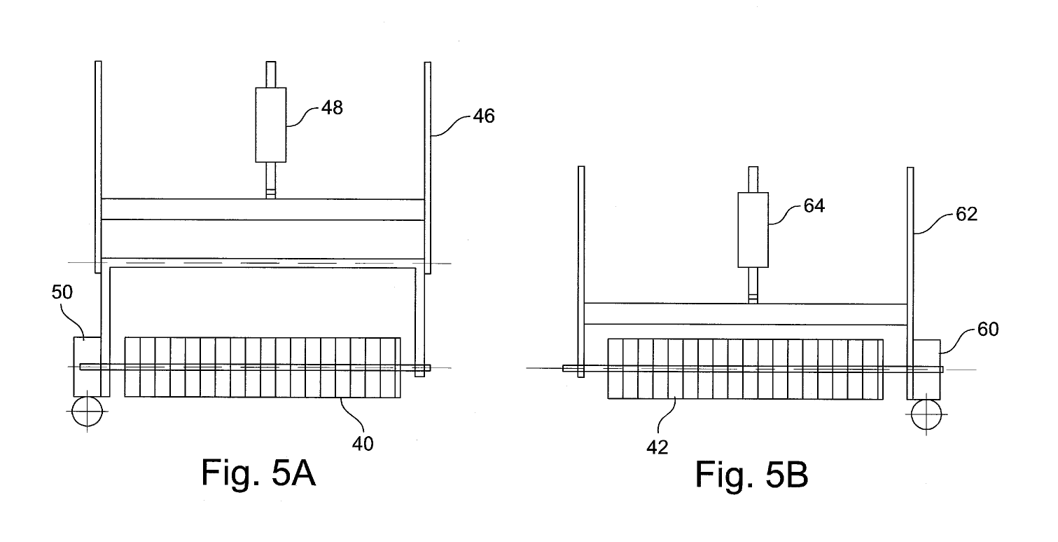

FIGS. 5A and 5B show two distinct components of the mould-release group belonging to the mould-release system of FIG. 1, respectively; and

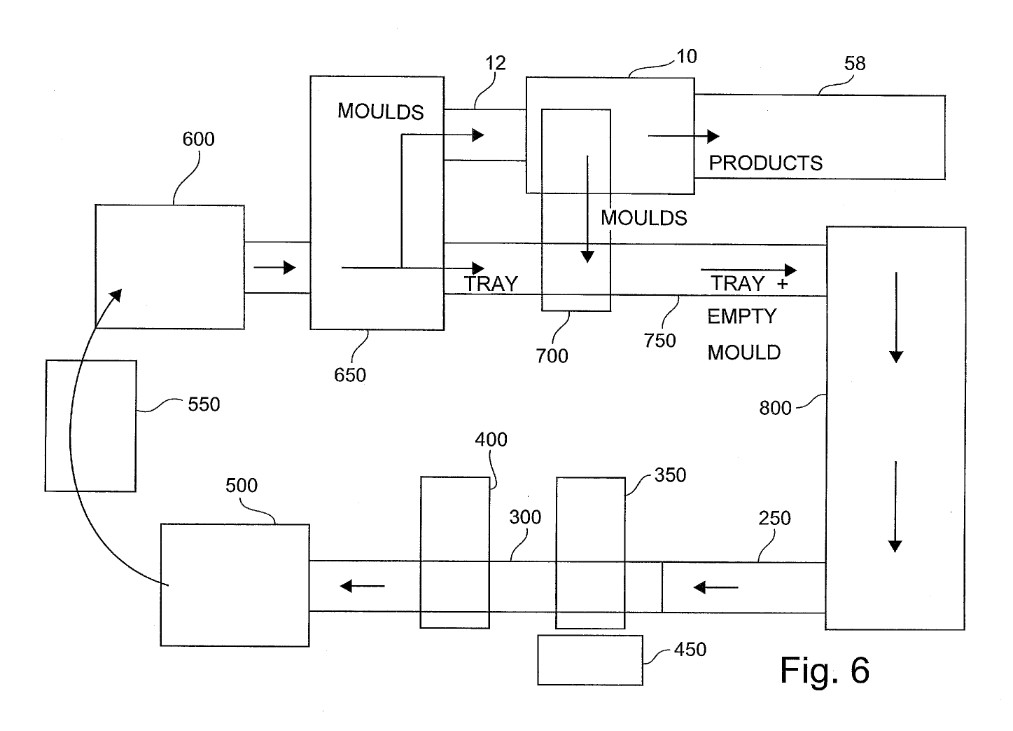

FIG. 6 is a schematic top plan view of a preferred exemplary embodiment of the mould-release system according to the present invention, associated to a generic plant for the manufacture of cast concrete products.

With reference to the figures, an exemplary preferred embodiment is shown of the system for the automatic release of products made from cast concrete from flexible moulds according to the present invention. The system is indicated as a whole by the reference numeral 10.

System 10 comprises in the first place an apparatus for supplying the moulds or dies 100 and for the pre-mould-release of products 200 contained within such moulds or dies 100. The supply and pre-mould release apparatus 12 in turn comprises a first conveyor belt 14 associated with a first pre-mould-release group 16, as well as a second conveyor belt 18 associated with a second pre-mould-release group 20. The second conveyor belt 18 is arranged downstream with respect to the first conveyor belt 14 and both pre-mould-release groups 16 and 20 are configured to facilitate the subsequent mould-release of products 200, obtained in the mould-release machine 22 positioned downstream both with respect to the first conveyor belt 14 and with respect to the second conveyor belt 18.

The first conveyor belt 14 and the second conveyor belt 18 convey moulds 100 towards a mould-release group 36 of the mould-release machine 22, described more in detail hereinafter and configured to carry out the extraction of products 200 from the respective moulds 100. Each mould 100, containing one or more products 200 and still allocated in the corresponding tray (not shown), comes from the “dry line” of the manufacturing plant of products 200 and is transferred onto the first conveyor belt 14 via an overturning machine 650 (see FIG. 6), configured to release moulds 100 with products 200 on such a first conveyor belt 14 and return the empty trays to the manufacturing plant of products 200.

At the end portion of the first conveyor belt 14, the mould 100, with products 200 therein, passes through the first pre-mould-release group 16. The first pre-mould-release group 16 consists of a lifting device 24 and of a gripping mechanism 26 properly shaped and operatively connected to such a lifting device 24. In detail, with reference to FIGS. 2A-2C, the lifting device 24 preferably consists of a pneumatic cylinder, while the gripping mechanism 26, when actuated by such a pneumatic cylinder 24, is movable with a reciprocating motion along a substantially vertical direction and orthogonal to the advance direction of the first conveyor belt 14.

Each mould 100 proceeds on the first conveyor belt until its front free edge, with reference to the advance direction of said first belt conveyor 14, is in contact with or in abutment on the gripping mechanism 26. The mould 100 then stops in this abutment position and its front free edge is lifted by the gripping mechanism 26, so as to cause the detachment of the front wall of products 200 from mould 100 itself. The first pre-mould-release group 16 is configured in such a way that, once the pneumatic cylinder 24 has reached the stroke end in the lifting step of the gripping mechanism 26, the gripping mechanism 26 is able to release the front free edge of the mould 100, which returns to abut on the surface of the first conveyor belt 14 (FIG. 2C). At this point, the mould 100 resumes its motion and, once the mould 100 itself has integrally surpassed the first conveyor belt 14, being on the second conveyor belt 18, the pneumatic cylinder moves the gripping mechanism 26 downwards waiting for the next mould 100.

Each mould 100 then passes on the second conveyor belt 18, where the second pre-mould-release group 20 is. The second pre-mould-release group 20 consists of one or more projecting or convex portions 28 (FIGS. 3A and 3B) of the surface of the second conveyor belt 18, as well as of at least one shaped roller 30 arranged above the second conveyor belt 18, at the projecting or convex surface portions 28 thereof, and rotating about a shaft 30A. The projecting or convex portions 28 and the shaped roller 30 are configured to jointly cause a first detachment of the lateral walls of the products 200 from the respective lateral walls of the mould 100, thus further facilitating the detachment of each product 200 from the mould 100 itself. At this point the mould 100, after having integrally surpassed the second conveyor belt 18, enters the mould-release machine 22 through a third conveyor belt 32 belonging to the mould-release machine 22 itself.

The third conveyor belt 32 is equipped with lifting means 34 of the front extreme end 44 of the third conveyor belt 32. Preferably, the lifting means 34 consist of a pneumatic cylinder. The mould-release machine 22 is instead provided with a mould-release group 36 operatively connected to the front extreme end 44 of the third conveyor belt 32. When a single mould 100 arrives at the front extreme end 44 of the third conveyor belt 32, which is hinged and controlled by the pneumatic cylinder 34, the pneumatic cylinder 34 lifts the front extreme end 44 of the third conveyor belt 32, thus pressing mould 100 against the mould-release group 36 with a predefined pressure specific to obtain the mould-release by friction of the products 200.

In detail, the mould-release group 36 is provided with a plurality of rollers or brushes 38, 40 and 42 provided with bristles made of a flexible material, such as a polymeric material of various formulas. Brushes 38, 40 and 42 are mounted on respective shafts 38A, 40A and 42A with rotating and mutually parallel axes. Shafts 38A, 40A and 42A are oriented along a direction substantially perpendicular to the development direction of the various conveyor belts 14, 18, 32, 54, 58 and 66. A first brush 38 is fixed to the frame of the mould-release machine 22, so as to have its rotation axis 38A in a well-defined position with respect to the position of the axis of the return drum placed at the front extreme end 44 of the third conveyor belt 32.

The first brush 38 is idle and is configured to rest on the upper surface of each mould 100, so as to rotate following the motion of the back of mould 100 itself in its path at the front extreme end 44 of the third conveyor belt 32. As shown in FIG. 4A, the front free edge of mould 100 is brought into contact with a second brush 40 (FIG. 5A), mounted on a first floating arm 46 actuated by a first moving and lifting system (comprising, for example, a first pneumatic cylinder 48) and set in rotation, at a predetermined speed, by a first motorisation device 50. The first floating arm 46 has the function of adapting the position of the second rotating brush 40 to the various possible sizes and shapes of mould 100. The second rotating brush 40 captures by friction the front free edge of the mould 100 and keeps it lifted and separated from the surface of the products 200.

While the third conveyor belt 32 continues its motion, a chain lifting mechanism 52 (or any other lifting system) connected to the first floating arm 46 at the same time makes the second rotating brush 40 carry out an arc of circumference upwards up to a predetermined position in proximity of a third rotating brush 42. The first floating arm 46 of the second rotating brush 40 is connected, through a pair of connecting rods 56, to a fourth conveyor belt 54 positioned downstream of the third conveyor belt 32. The rear extreme end of the fourth conveyor belt 54 can thus be lifted so that, when it reaches the “high” position at the third rotating brush 42, the fourth conveyor belt 54 is aligned with the third conveyor belt 32, allowing products 200 to pass without problems from the third conveyor belt 32 to the fourth conveyor belt 54 and, therefore, to a fifth conveyor belt 58 configured to transfer such products 200 outside the mould-release machine 22.

The third brush 42 is set in rotation, at a predetermined speed, by a second motorisation device 60 (FIG. 5B) and is connected to the frame of the mould-release machine 22 via a second floating arm 62. The second floating arm 62 is hinged to the frame of the mould-release machine 22 and its position is adjusted by a second moving and lifting system (comprising, for example, a second pneumatic cylinder 64). Mould 100 is thus sucked into a cavity formed by the three brushes 38, 40 and 42 when these brushes 38, 40 and 42 are located adjacent to each other (FIG. 4B) and is forced to flex following the profile of the first idle brush 38. Products 200, instead, being rigid, do not follow the forced flexing of the mould 100 and detach completely from it by following the straight direction imposed by the surface of the third conveyor belt 32, thus going to abut on the subsequent fourth conveyor belt 54.

The mould-released products 200, i.e. extracted from the respective mould 100 and with their “noble” or shaped surface already facing upwards, are moved by the fifth conveyor belt 58 to be transferred outside the mould-release machine 22 in the direction of the quality control and packaging area. In the meantime, the empty mould 200 is pushed by brushes 38, 40 and 42 towards a sixth conveyor belt 66, on which said mould 200 is positioned with its cavities (where products 200 were previously inserted) facing upwards.

Once all of the empty mould 100 has surpassed the mould-release group 36, the second rotating brush 40 returns to its rest position, waiting for the arrival of a new mould 100 to be mould-released. The sixth conveyor belt 66, preferably arranged parallel to the other conveyor belts 14, 18, 32, 54 and 58 and moved in the opposite direction with respect to the moving direction of such conveyor belts 14, 18, 32, 54 and 58, then sends each empty mould 100 up to a predetermined collection point, from which such empty mould 100 is picked and repositioned within its tray on the “dry line” of the manufacturing plant of products 200 (FIG. 6).

The system 10 for automatic mould-release of products 200 so far described, using the flexibility of brushes 38, 40 and 42 of the mould-release group 36, the automatic adjustment capabilities of the lifting means 34 of the third conveyor belt 32 and of the moving and lifting systems 48 and 64 of the rotating brushes 40 and 42, as well as the natural flexibility of moulds 100, allows the products 200 to be mould-released without the need of gripping elements for moving and flexing the mould 100 and without the need for the presence of labour.

As shown in FIG. 6, the system 10 for the automatic mould-release of products 200 described so far can be inserted into a both a manual and an automatic plant for the manufacture of cast concrete products. In both cases, the plant for the manufacture of cast concrete products consists of two production lines, i.e. a line on which the fresh products transit and a line on which the dry products transit. The fresh products line consists of a coating area where a layer of paint is applied manually or via an automated system to moulds 100, already sprayed with a detaching agent, which will impart the final colour of the respective “noble” or shaped surface to products 200.

Subsequently, moulds 100 pass through a concrete casting apparatus, where they are filled and vibrated and where the excess material is scraped and removed from the top of each mould 100. These operations can be carried out either manually or through automatic dispensing, vibration and scraping systems. Moulds 100 thus filled are then left to rest in proper curing chambers to allow the concrete to solidify.

Once the concrete has reached the required degree of curing, the moulds 100 pass on the dry products line, where the products 200 are separated from the moulds 100, subjected to quality control and packaged for sale. Moulds 100 are instead cleaned and directed again towards the fresh products line to be subjected to a new production cycle.

If the system 10 according to the present invention is inserted in an automatic plant for the manufacture of cast concrete products, such a system 10 is arranged parallel to the line on which the dry products transit. Normally, the extraction operation of the products 200 from the moulds 100 is carried out manually, but with the system 10 according to the present invention it is possible to carry out this operation in a totally automatic manner.

A typical automatic plant for the manufacture of cast concrete products is described hereinafter and is schematically shown, in one of its possible configurations, in FIG. 6. The mould 100, made of rubber or deformable plastic, arranged in a dedicated metal/wood tray designed to be self-stacking to prevent the use of crates, enters the line on which the fresh products transit along a conveyor belt 250. Mould 100 then passes on a vibrating belt 300 where a dispensing machine 350 and a scraping machine 400 are provided. As shown in FIG. 6, the dispensing machine 350 is powered by a machine 450 that allows the transfer of the fresh concrete from the mixer to the filling area of the moulds 100.

The mould 100, once filled, scraped and vibrated, reaches an automatic stacking device 500 that creates a stack formed by a well-defined number of moulds 100 with products 200 just cast therein. At this point, a forklift carries the whole stack towards one or more curing chambers 550 inside which a drying process of products 200 occurs.

Once curing is complete, the forklift picks up the stack of moulds 100 with dry products 200 therein and places it on an automatic destacker 600 which, one by one, conveys the moulds 100 to an overturning machine 650. Such an overturning machine 650 performs a rotation by 180° and unloads each mould 100 with products 200 therein on the mould-release line, while the tray is repositioned on the dry products line waiting for mould 100, emptied of products 200, is arranged back inside it by a repositioning gripper 700.

The mould 100 with the products 200 therein then passes through the system 10 according to the present invention, which conveys the extracted products 200 on the fifth conveyor belt 58 towards the quality control and packaging area, while the mould 100 is arranged back into the tray. Once the mould/tray pair has been reassembled, it travels along the belt 750, with which a lubricating station may be associated, and arrives at a deviating machine 800 which connects the dry products line to the fresh products line. The deviating machine 800 then unloads the tray/mould pair onto the belt 250 and the production cycle can begin again.

It has thus been seen that the system for the automatic mould-release of cast concrete products from flexible moulds according to the present invention achieves the objects outlined above. The system for the automatic release of cast concrete products from flexible moulds of the present invention allows the mould-release of the products from the respective moulds in a totally automatic manner, without the need for labour. The system can work with moulds of various sizes and with even complex product geometries, adjusting itself and without the need for downtime to configure the system itself.

The products are extracted by using the flexibility of the moulds and without the risk of breakage or damage of the products in the mould-release step. The products leaving the system are already with the “noble” or shaped surface facing upwards, thereby facilitating quality control on the product surface and further reducing labour costs and time. Overall, the set of these features allows greatly reducing the labour needed, and thus leads to a considerable decrease in costs and also to a great flexibility of the production process.

The system for the automatic release of cast concrete products from flexible moulds of the present invention thus conceived is susceptible in any case to numerous modifications and variations, all falling within the same inventive concept; moreover, all details can be replaced by technically equivalent elements. In the practice, the materials used as well as shapes and sizes, may be any, according to the technical requirements.

The scope of protection of the invention is therefore defined by the accompanying claims.

1. A system for the automatic release of products made from cast concrete from flexible and deformable moulds, the system comprising:
an apparatus configured to supply said moulds and to carry out the pre-mould-release of the products contained inside said moulds, said apparatus comprising a first conveyor belt associated with a first pre-mould-release group, wherein said first pre-mould-release group is configured to facilitate the subsequent mould-release of the products; and
a mould-release machine arranged downstream with respect to the first conveyor belt, said mould-release machine comprising a mould-release group, configured to carry out the extraction of the products from the respective moulds, and a plurality of conveyor belts, configured to carry out the movement of the moulds and of the products inside the mould-release machine, wherein said mould-release group is provided with a plurality of mould-release means configured to carry out the detachment of each product from the respective mould through a forced flexing of said mould,
the system wherein said apparatus comprises a second conveyor belt associated with a second pre-mould-release group, wherein said second conveyor belt is arranged downstream with respect to the first conveyor belt, wherein said mould-release machine is arranged downstream with respect to said second conveyor belt and wherein said second conveyor belt is configured to facilitate the subsequent mould-release of the products, and in that said plurality of conveyor belts comprises a third conveyor belt configured to receive the moulds from said second conveyor belt and provided with lifting means for lifting the front extreme end of said third conveyor belt, said lifting means being configured to lift said front extreme end to push each mould against the mould-release group through a predetermined and specific pressure to obtain the mould-release by friction of said products.

2. The system according to claim 1, wherein said mould-release means are operatively connected to the front extreme end of the third conveyor belt and consist of a plurality of rollers or brushes mounted on respective shafts with rotating axes, parallel to each other and oriented along a direction substantially perpendicular to the development direction of said conveyor belts.

3. The system according to claim 2, wherein said plurality of rollers or brushes comprises a first idle brush, fixed to the frame of the mould-release machine in order to have its rotation axis arranged at the front extreme end of the third conveyor belt, said first brush being configured to rest on the upper surface of each mould so as to rotate following the motion of the back of said mould while moving forward at said front extreme end of the third conveyor belt.

4. The system according to claim 3, wherein said plurality of rollers or brushes comprises a second brush mounted on a first floating arm hinged to the frame of the mould-release machine and actuated by a first moving and lifting system, wherein said second brush is set in rotation, at a predetermined speed, by a first motorisation device and wherein said first floating arm is configured to adapt the position of said second brush to the various possible sizes and shapes of each mould, so that said second brush is able to capture by friction the front free edge of said mould to keep it lifted and separated from the surface of the products.

5. The system according to claim 4, wherein said plurality of rollers or brushes comprises a third brush mounted on a second floating arm hinged to the frame of the mould-release machine and actuated by a second moving and lifting system, wherein said third brush is set in rotation, at a predetermined speed, by a second motorisation device so that, when said first brush, second brush and third brush are adjacent to each other, each mould is sucked into a cavity formed by said three brushes and is forced to bend following the profile of the first brush.

6. The system according to claim 5, wherein said first floating arm is connected both to a lifting mechanism, configured to make the second brush carry out an arc of circumference upwards up to a predetermined position close to the third brush, and to a fourth conveyor belt arranged downstream of the third conveyor belt, wherein the rear extreme end of said fourth conveyor belt can be lifted so as to receive the products separated from the respective mould and transfer them to a fifth conveyor belt configured to transfer said products out of the mould-release machine.

7. The system according to claim 5, wherein plurality of conveyor belts comprises a sixth conveyor belt configured both to receive each empty mould when pushed by said plurality of rollers or brushes, and to send said empty mould up to a predetermined collection point.

8. The system according to claim 7, wherein said sixth conveyor belt is arranged parallel to the other conveyor belts and is moved in the opposite direction with respect to the direction of movement of said conveyor belts.

9. The system according to claim 5, wherein said lifting means, said first moving and lifting system and said second moving and lifting system respectively consist of pneumatic cylinders.

10. The system according to claim 1, wherein the first pre-mould-release group consists of a lifting device and of a gripping mechanism operatively connected to said lifting device, said gripping mechanism being configured to lift the front free edge of each mould so as to cause the detachment of the front wall of the products (200) from said mould.

11. The system according to claim 1, wherein the second pre-mould-release group consists of one or more projecting or convex portions of the surface of the second conveyor belt, as well as of at least one shaped roller arranged above said second conveyor belt, at its projecting or convex surface portions, said projecting or convex surface portions and said shaped roller being configured to jointly cause a first detachment of the lateral walls of the products from the respective lateral walls of the moulds.

12. A plant for manufacturing products made from cast concrete comprising:
a production line on which the fresh products transit;
one or more curing chambers inside which a drying process of the products occurs;
a production line on which the dry products transit; and
a deviating machine that connects the production line on which the fresh products transit with the production line on which the dry products transit,
wherein the production line on which the dry products transit comprises a system for the automatic mould-release of the products according to claim 1.
